(19) United States
(12) Patent Application Publication
(10) Pub. No.: US 2013/0325466 A1
(43) Pub. Date: Dec. 5, 2013

(54) SYSTEM AND METHOD FOR CONTROLLING INTERACTIVE VIDEO USING VOICE

(71) Applicant: CLICKBERRY, INC., LOAS ALTOS, CA (US)

(72) Inventor: ALEXEY BABIN, PALO ALTO, CA (US)

(21) Appl. No.: 13/892,240

(22) Filed: May 10, 2013

Related U.S. Application Data
(60) Provisional application No. 61/645,510, filed on May 10, 2012.

(51) Int. Cl. H04N 21/482

(52) U.S. Cl. CPC H04N 21/482
USPC 704/235

(57) ABSTRACT

System for controlling interactive video using voice commands incorporates: a control module, a voice-to-text conversion module, a text comparison module, an interactive content overlay module, a dynamic content display module, and a content storage module. The control module is implemented as a mobile application executing on a suitable mobile device, which is configured to transmit voice commands received from the user to the server. The voice-to-text conversion module operates on the server and performs conversion of the user's voice commands to text commands. The text comparison module is deployed on provider's server and performs comparison of the words in the converted text commands received from the conversion module with the keywords stored in the interactive video file. The interactive content overlay module displays the interactive content corresponding to the user's commands by overlaying it over the video content displayed to the user. The dynamic content display module dynamically displays the interactive content to the user. The content storage module controls the storing of the content on the server.

### CROSS-REFERENCE TO RELATED PATENT APPLICATIONS

This non-provisional patent application is based on and claims the benefit of priority from U.S. provisional patent application No. 61/645,510 filed on May 10, 2012, the entire disclosure of which is incorporated by reference herein.

### BACKGROUND OF THE INVENTION

1. Field of the Invention

This invention relates in general to methods and systems for providing interactive video and, more particularly, to providing methods and systems for controlling interactive video using voice commands.

2. Description of the Related Art

Interactive video (IV) consists of video and, optionally, audio content combined with certain integrated interactive features, played to an audience, which may include one or more users. The interactive video is demonstrated to the user or users using a special software environment being executed on a computer platform. This special software environment for demonstrating interactive video, hereinafter called IVS, operates to show the video/audio (AV) content to the user or users, detect certain actions performed by the user or users during the AV content demonstration and perform certain predetermined operations based on the video/audio content and the user's actions detected by the IVS. The interaction may be of iterative nature, when after the first round of interaction, the user performs additional actions and/or issues additional commands, which are appropriately acted upon by the IVS. Thereafter, the demonstration of the AV content is resumed or additional interaction takes place.

While there exist on the market certain interactive video systems, they primarily rely on user's performing interaction with the video content using mouse or keyboard clicks. On the other hand, human voice is a more natural and intuitive way for a human to issue various control commands and otherwise engage in interaction. Therefore, there is a need for systems and methods that enable controlling interactive video using voice commands.

### SUMMARY OF THE INVENTION

The inventive methodology is directed to methods and systems that substantially obviate one or more of the above and other problems associated with conventional techniques for controlling interactive video.

In accordance with one aspect of the inventive concept, there is provided a computerized system for controlling interactive video using voice commands, the system comprising: a control module deployed on a mobile device and configured to detect a voice command issued by a user and to transmit the detected user's voice command to the server; a voice-to-text conversion module deployed on the server and configured to perform conversion of the user's voice command to a text command; a text comparison module configured to perform comparison of the words in the converted text command received from the voice-to-text conversion module with keywords stored in an interactive video file; an interactive content overlay module configured to display an interactive content corresponding to the user's voice command by overlaying the interactive content over a video content displayed to the user; a dynamic content display module configured to dynamically display the interactive content to the user; and a content storage module configured to control storing of the interactive video file containing the interactive content.

In one or more embodiments, the interactive video file comprises: positional coordinates of an object in the video frame of the interactive video; a time interval when the object appears in the video; at least one keyword associated with the object; a type of interactive action to be initiated upon the receipt of the command from the user; and a content to be displayed to the user.

In one or more embodiments, the keywords comprise content keywords associated with one or more objects in the interactive video file and command keywords associated with one or more actions, which may be performed in connection with the interactive video.

In one or more embodiments, the interactive content overlay module is configured to display the interactive content corresponding to the user's voice command in a translucent manner.

In one or more embodiments, the interactive content overlay module is configured to display the interactive content corresponding to the user's voice command in a pop-up window.

In one or more embodiments, the computerized system is configured to display a hint to the user regarding one or more actions which may be performed in connection with the interactive video.

In one or more embodiments, the computerized system is configured to send email comprising the interactive content corresponding to the user's voice command to the user.

In accordance with another aspect of the inventive concept, there is provided a computer-implemented method for controlling interactive video using voice commands, the method comprising: using a control module deployed on a mobile device and configured to detect a voice command issued by a user and to transmit the detected user's voice command to the server; using a voice-to-text conversion module deployed on the server and configured to perform conversion of the user's voice command to a text command; using a text comparison module configured to perform comparison of the words in the converted text command received from the voice-to-text conversion module with keywords stored in an interactive video file; using an interactive content overlay module configured to display an interactive content corresponding to the user's voice command by overlaying the interactive content over a video content displayed to the user; using a dynamic content display module to dynamically display the interactive content to the user; and using a content storage module to control storing of the interactive video file containing the interactive content.

In one or more embodiments, the interactive video file comprises: positional coordinates of an object in the video frame of the interactive video; a time interval when the object appears in the video; at least one keyword associated with the object; a type of interactive action to be initiated upon the receipt of the command from the user; and a content to be displayed to the user.

In one or more embodiments, the keywords comprise content keywords associated with one or more objects in the interactive video file and command keywords associated with one or more actions, which may be performed in connection with the interactive video.

In one or more embodiments, the interactive content corresponding to the user's voice command is displayed in a translucent manner.

In one or more embodiments, the interactive content corresponding to the user's voice command is displayed in a pop-up window.

In one or more embodiments, the method further comprises displaying a hint to the user regarding one or more actions, which may be performed in connection with the interactive video.

In one or more embodiments, the method further comprises sending email comprising the interactive content corresponding to the user's voice command to the user.

In accordance with yet another aspect of the inventive concept, there is provided a non-transitory computer-readable medium embodying a set of instructions, which, when executed by one or more processors cause the one or more processors to perform a computer-implemented method for controlling interactive video using voice commands, the method comprising: using a control module deployed on a mobile device and configured to detect a voice command issued by a user and to transmit the detected user's voice command to the server; using a voice-to-text conversion module deployed on the server and configured to perform conversion of the user's voice command to a text command; using a text comparison module configured to perform comparison of the words in the converted text command received from the voice-to-text conversion module with keywords stored in an interactive video file; using an interactive content overlay module configured to display an interactive content corresponding to the user's voice command by overlaying the interactive content over a video content displayed to the user; using a dynamic content display module to dynamically display the interactive content to the user; and using a content storage module to control storing of the interactive video file containing the interactive content.

In one or more embodiments, the interactive video file comprises: positional coordinates of an object in the video frame of the interactive video; a time interval when the object appears in the video; at least one keyword associated with the object; a type of interactive action to be initiated upon the receipt of the command from the user; and a content to be displayed to the user.

In one or more embodiments, the keywords comprise content keywords associated with one or more objects in the interactive video file and command keywords associated with one or more actions, which may be performed in connection with the interactive video.

In one or more embodiments, the interactive content corresponding to the user's voice command is displayed in a translucent manner.

In one or more embodiments, the interactive content corresponding to the user's voice command is displayed in a pop-up window.

In one or more embodiments, the method further comprises displaying a hint to the user regarding one or more actions, which may be performed in connection with the interactive video.

Additional aspects related to the invention will be set forth in part in the description which follows, and in part will be obvious from the description, or may be learned by practice of the invention. Aspects of the invention may be realized and attained by means of the elements and combinations of various elements and aspects particularly pointed out in the following detailed description and the appended claims.

It is to be understood that both the foregoing and the following descriptions are exemplary and explanatory only and are not intended to limit the claimed invention or application thereof in any manner whatsoever.

### BRIEF DESCRIPTION OF THE DRAWINGS

The accompanying drawings, which are incorporated in and constitute a part of this specification exemplify the embodiments of the present invention and, together with the description, serve to explain and illustrate principles of the inventive technique. Specifically:

FIG. 1 illustrates an exemplary embodiment of the inventive system for controlling interactive video using voice commands.

FIG. 2 illustrates an exemplary operating sequence of an inventive method for controlling interactive video using voice commands usable in connection with the system shown in FIG. 1.

FIG. 3 illustrates an exemplary embodiment of a computer platform upon which the inventive system may be implemented.

### DETAILED DESCRIPTION

In the following detailed description, reference will be made to the accompanying drawing(s), in which identical functional elements are designated with like numerals. The aforementioned accompanying drawings show by way of illustration, and not by way of limitation, specific embodiments and implementations consistent with principles of the present invention. These implementations are described in sufficient detail to enable those skilled in the art to practice the invention and it is to be understood that other implementations may be utilized and that structural changes and/or substitutions of various elements may be made without departing from the scope and spirit of present invention. The following detailed description is, therefore, not to be construed in a limited sense. Additionally, the various embodiments of the invention as described may be implemented in the form of a software running on a general purpose computer, in the form of a specialized hardware, or combination of software and hardware.

### Inventive Interactive Video System

An exemplary interactive video system is described in U.S. patent application Ser. No. 13/776,701, incorporated by reference herein. Various aspects of the present invention provide various systems and methods for controlling and otherwise interact with interactive video using voice commands. In one embodiment, there is provided a special software interactive video player (IVS) deployed on a computer platform and designed to play interactive video in a special format. The aforesaid application allows the user to manage the process of playing an interactive video with voice commands. In one or more embodiments, the aforesaid IVS plays interactive video, detects the user's voice command, decodes it and performs the action associated with the detected and decoded user command in connection with the interactive video being played.

In one or more embodiments, the player is configured to play one of multiple types video files having interactive layout, such as .mp4 files. Exemplary embodiments of the aforesaid interactive video files are described in detail in the aforesaid U.S. patent application Ser. No. 13/776,701, incorporated by reference herein. As would be appreciated by those of skill in the art, the exact types of interactive video files playable by the inventive IVS are not critical to the present invention. In one or more embodiments, after selecting a video file, the IVS player is configured to open it in full screen mode and start playing the interactive video content to the user.

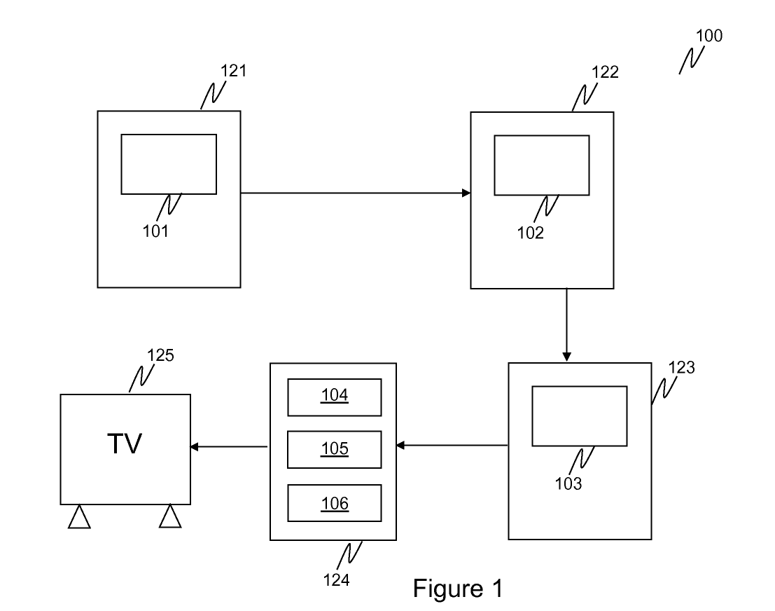

FIG. 1 illustrates an exemplary embodiment of an inventive system for controlling interactive video using voice commands. In one or more embodiments illustrated in FIG. 1, the inventive IVS 100 comprises at least the following modules: a control module 101, a voice-to-text conversion module 102, a text comparison module 103, an interactive content overlay module 104, a dynamic content display module 105, and a content storage module 106. The control module 101 may be implemented as a mobile application executing on a suitable mobile device 121, and which is configured to transmit voice commands received from the user to the server. It should be noted that the inventive control module 101 is not limited to any specific mobile operating system (OS) or any specific mobile device. Thus, any suitable mobile device or mobile OS may be employed for deploying the control module 101.

In one or more embodiments, the voice-to-text conversion module 102 operates on the server 122 shown in FIG. 1 and performs conversion of the user's voice commands to text commands. The text comparison module 103 is deployed on provider's server 123 and performs comparison of the words in the converted text commands received from the conversion module 101 with the keywords stored in the interactive video file. The interactive content overlay module 104 displays the interactive content corresponding to the user's commands by overlaying it over the video content displayed to the user. The dynamic content display module 105 dynamically displays the interactive content to the user. Specifically, the module displays the requested information to the audience on the screen by downloading it from the server. Finally, the content storage module 106 controls the storing of the content on the server. The modules 104-106 may be deployed on the content server 124. In the shown exemplary embodiment, the content is shown to the audience using plasma or LCD TV 125.

In one or more embodiments, the inventive IVS enables the viewer to control the playback with voice commands. Specifically, in one or more embodiments, the voice control commands supported by one or more embodiments of the inventive IVS include one or more of the following:

1) A command to pause or stop the video;

2) A command to resume or continue playing the video after pause;

3) Fast forward/rewind the video for a specified number of seconds;

4) Rewind the video to the beginning, also called “Start over”;

5) Initiate a pre-defined (in the file layout) action requested by the user; and/or

6) Perform a function “send it to my email”, wherein certain information provided to the user in course of interaction with the interactive video content is sent to the user's email account or email account of another person. In one or more embodiments, the inventive IVS may incorporate a built-in email client, which automatically receives the content associated with the object of interest. The user may be prompted to enter the recipient's address and press the button “send”, which would result in the email message with the content being sent to the specified recipient.

In one or more embodiments, there is provided a novel interactive layout for video content, which may include the following data blocks for each object in the video:

1) The positional coordinates of the object in the video frame of the interactive video (example: x, y);

2) The time interval when the object appears in the video (example: from 1:32 to 2:41);

3) Keywords associated with the object. As it would be appreciated by persons of ordinary skill in the art, the used keywords will be dependent on the nature and properties of the object. For example, if the object in the video is a person wearing a blue jacket, the associated keywords may be, without limitation, “jacket” and/or “blue”.

4) The type of interactive action to be initiated upon the receipt of a command from the viewer. Exemplary commands may include, without limitation, the automatic opening of a “pop-up” window with information about the object; and

5) The actual content that is displayed to the user (example: photo “blue jacket”, price and description).

In one or more embodiments, a special tag <keyword> is added to the interactive video file, such as a file in .aysx format known to persons of ordinary skill in the art. This tag is related to a tag <hotspot> and serves to identify keywords, which are configured to trigger actions on the object.

In one or more embodiments, the operation of the inventive IVS will be illustrated using an exemplary 15-second long (from 00:00 to 00:15) video segment from the popular television show “Sex and the City.” In one or more embodiments, the inventive ISV associates the aforesaid exemplary video segment with the following interactive objects:

1) Hotel;

2) Doormen;

3) Actress Sarah Jessica Parker;

4) White Dress;

5) Glasses;

6) Necklace;

7) Handbag;

8) Shoes;

9) A man with flowers;

10) A tree in a large pot at the hotel entrance;

11) A passerby with a music player;

12) The player held by the passerby;

13) Pants worn by the passerby;

14) Sweater worn by the passerby;

15) Transparent bag held by Sarah Jessica Parker;

16) Suitcase carried by Sarah Jessica Parker;

17) Sarah Jessica Parker's blue bag; and

18) Sarah Jessica Parker's white bag.

In one or more embodiments, each of the above objects in the interactive video segment is associated with one or more content keywords, actions, and types of interactive content, which may be stored by the inventive system. In one exemplary implementation, the embodiment of the inventive ISV may associate object number four (white dress) with the following associated data blocks:

1) Associated content keywords may include: “Dress,” “Tunic,” “White,” “Actress”, “Sarah”, “Sarah Jessica Parker,” “Carrie,” and “ Carrie Bradshaw.”

2) Associated action may include: Open content in a pop-up window.

3) Associated content may include: A photo of dress, its brand name and price.

4) Additional associated actions may include: “mail me this info”, which operates to email the info on the object to the user's email address.

5) The time interval when the object appears in the video is from 00:02 to 00:11 seconds.

In one exemplary implementation, the inventive ISV operates in the following manner:

1) A command is received from the user to start the video. The aforesaid command is received by the control module 101 residing on the mobile device and transmitted to the server executing the voice-to-text conversion module 102, where it is converted to text. The resulting text is analyzed and the action corresponding to the user's command is identified. In one or more embodiments, this can be accomplished by comparing the converted text to a set of predetermined command keywords, such as “start” and “video.” The command keywords may be also stored by the inventive system. Upon detection of the appropriate match of the converted text and predetermined command keyword, the inventive ISV starts the video.

2) When the user observes the white dress, he announces a command and initiates a keyboard or mouse click, which is detected by the system. The user's command may be in a form: “Clickberry stop the video” or simply “Clickberry stop!”

3) The received voice command is picked up by the control module 101 residing on the mobile device and transmitted to the server executing the voice-to-text conversion module 102, where it is converted to text. The resulting text is analyzed and the action corresponding to the user's command is identified. In one or more embodiments, this can be accomplished by comparing the converted text to a set of predetermined command keywords, such as “stop” and “video.” Thereafter, the inventive ISV stops the video based on the received command.

4) The user utters a command “Clickberry, show me a white dress on Carrie.”

5) The received voice command is picked up by the control module 101 residing on the mobile device and transmitted to the server executing the voice-to-text conversion module 102, where it is converted to text. The text comparison module 103 then compares the text command “Show me a white dress on Carrie” with a set of content keywords associated with all the objects present in the corresponding video segment or frame. In the aforesaid example, the matching content keywords may include: “Dress”, “Tunic”, “White”, “Actress”, “Sarah”, “Sarah Jessica Parker”, “Carrie” and Carrie Bradshaw.” In addition, the resulting converted text is analyzed and the action corresponding to the user's command is identified. In one or more embodiments, this can be accomplished by comparing the converted text to a set of predetermined command keywords, such as “show” and “me.”

6) Based on the matching keywords, the inventive IVS performs the corresponding operation, which may include displaying a pop-up window with the content on the screen.

7) The control module 101 then receives another command from the user, such as “Clickberry, send it to me by email!”

8) The command is transmitted to the server executing the voice-to-text conversion module 102, where it is converted to text. The resulting text is analyzed and the action corresponding to the user's command is identified. In one or more embodiments, this can be accomplished by comparing the converted text to a set of predetermined command keywords, such as “send” and “email.” Thereafter, the inventive ISV activates an email program and the content is sent to the user via email.

9) The control module 101 then receives “Clickberry, close!” command from the user. The command is transmitted to the server executing the voice-to-text conversion module 102, where it is converted to text. The resulting text is analyzed and the action corresponding to the user's command is identified. In one or more embodiments, this can be accomplished by comparing the converted text to a set of predetermined command keywords, such as “Clickberry” and “close.”

10) Based on the received command, the inventive IVS is configured to close the pop-up window and the video will automatically continue.

In one or more embodiments, during video playback, the inventive IVS is configured to display a special graphical primitive, such as a button. In one or more embodiments, this primitive may be displayed in a corner of a screen. When the system detects activation of this button by the user, it is configured to automatically pause the video and wait for the user's voice command.

In one or more embodiments, the end of the user's voice command is determined by the event when the user releases the aforesaid button, or after a predetermined time interval (such as 7 seconds) of the video pausing, whichever comes first. After the received voice command is picked up by the control module 101 residing on the mobile device, it is transmitted to the server executing the voice-to-text conversion module 102, where it is converted to text. The text comparison module 103 then compares the text of the command with a set of content keywords. In one or more embodiments, upon detecting of the clicking on the button on the screen, the system is configured to display a hint in a translucent window, such as “speak please”.

In one or more embodiments, the inventive IVS player may be configured to display hints regarding actions or content associated with each object appearing in the interactive video. This may be accomplished using graphical icons. For example, an icon resembling a shopping bag may be displayed adjacent to the white dress in the video. In another example, a mail icon may be displayed next to content that can be sent by email to the user. In one or more embodiments, the aforesaid hints are displayed responsive to user's voice command, such as “Show hints.” In one or more embodiments, the hints may be displayed in a translucent manner and may overlay the associated content.

In one or more embodiments, the creators of the video file are responsible for ensuring that different objects are assigned different keywords or that different objects corresponding to identical assigned keywords do not appear in the video at the same time. In one or more embodiments, if, still, the keywords assigned to different contemporaneous objects are the same, the action is performed on the first object that matches the keyword.

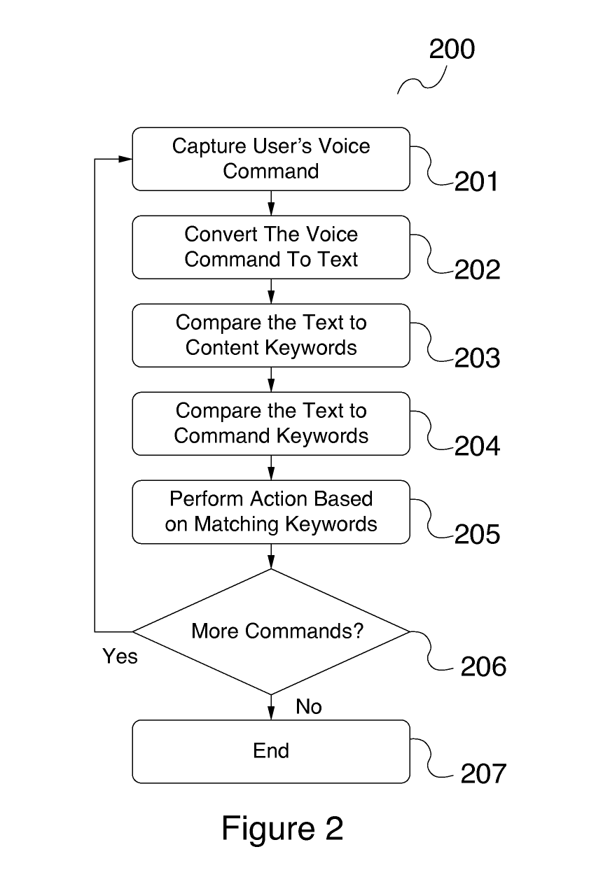

FIG. 2 illustrates an exemplary operating sequence 200 of an inventive method for controlling interactive video using voice commands usable in connection with the system 100 shown in FIG. 1.

At step 201, the user's voice command is captured by the control module 101. The control module 101 may reside on the mobile device of the user. At step 202, the voice command is converted to text using the voice-to-text conversion module 102. At step 203, the text generated in step 202 is compared to a predetermined set of content keywords using the text comparison module 103 and the marching content keywords are identified. At step 204, the text generated in step 202 is compared to a predetermined set of command keywords and the marching command keywords are identified. At step 205, an appropriate action is performed based on the matching content keywords and the command keywords. The process is repeated for additional commands, see step 206. The process terminates at step 207.

### Exemplary Computer Platform

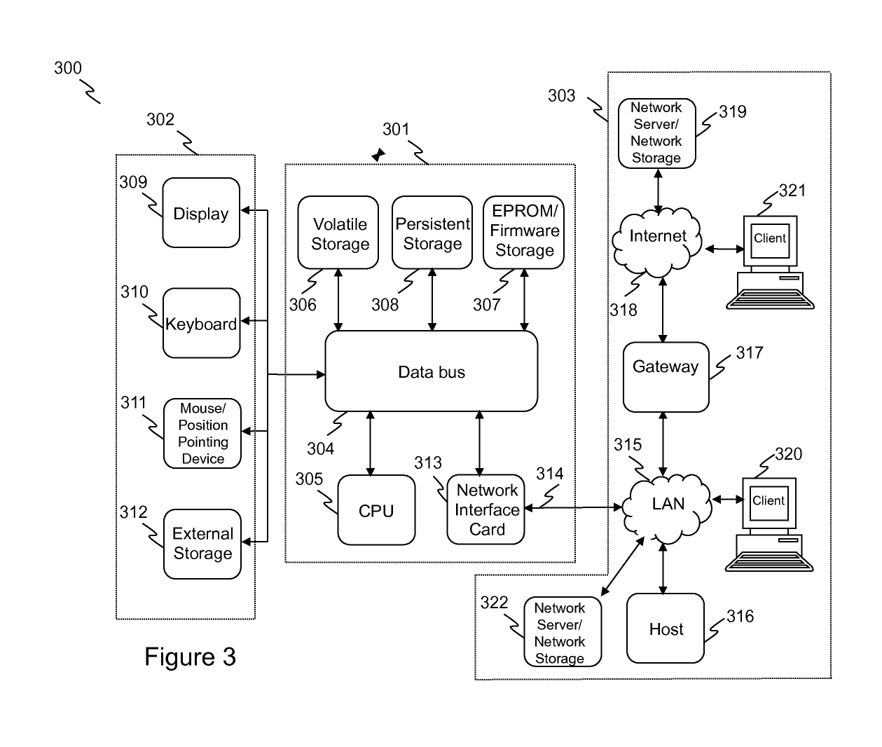

FIG. 3 illustrates an exemplary embodiment of a computer platform upon which the inventive system may be implemented.

FIG. 3 is a block diagram that illustrates an embodiment of a computer/server system 300 upon which an embodiment of the inventive methodology may be implemented. The system 300 includes a computer/server platform 301, peripheral devices 302 and network resources 303.

The computer platform 301 may include a data bus 305 or other communication mechanism for communicating information across and among various parts of the computer platform 301, and a processor 305 coupled with bus 301 for processing information and performing other computational and control tasks. Computer platform 301 also includes a volatile storage 306, such as a random access memory (RAM) or other dynamic storage device, coupled to bus 305 for storing various information as well as instructions to be executed by processor 305. The volatile storage 306 also may be used for storing temporary variables or other intermediate information during execution of instructions by processor 305. Computer platform 301 may further include a read only memory (ROM or EPROM) 307 or other static storage device coupled to bus 305 for storing static information and instructions for processor 305, such as basic input-output system (BIOS), as well as various system configuration parameters. A persistent storage device 308, such as a magnetic disk, optical disk, or solid-state flash memory device is provided and coupled to bus 301 for storing information and instructions.

Computer platform 301 may be coupled via bus 305 to a display 309, such as a cathode ray tube (CRT), plasma display, or a liquid crystal display (LCD), for displaying information to a system administrator or user of the computer platform 301. An input device 310, including alphanumeric and other keys, is coupled to bus 301 for communicating information and command selections to processor 305. Another type of user input device is cursor control device 311, such as a mouse, a trackball, or cursor direction keys for communicating direction information and command selections to processor 305 and for controlling cursor movement on display 309. This input device typically has two degrees of freedom in two axes, a first axis (e.g., x) and a second axis (e.g., y), that allows the device to specify positions in a plane.

An external storage device 312 may be coupled to the computer platform 301 via bus 305 to provide an extra or removable storage capacity for the computer platform 301. In an embodiment of the computer system 300, the external removable storage device 312 may be used to facilitate exchange of data with other computer systems.

The invention is related to the use of computer system 300 for implementing the techniques described herein. In an embodiment, the inventive system may reside on a machine such as computer platform 301. According to one embodiment of the invention, the techniques described herein are performed by computer system 300 in response to processor 305 executing one or more sequences of one or more instructions contained in the volatile memory 306. Such instructions may be read into volatile memory 306 from another computer-readable medium, such as persistent storage device 308. Execution of the sequences of instructions contained in the volatile memory 306 causes processor 305 to perform the process steps described herein. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to processor 305 for execution. The computer-readable medium is just one example of a machine-readable medium, which may carry instructions for implementing any of the methods and/or techniques described herein. Such a medium may take many forms, including but not limited to, non-volatile media and volatile media. Non-volatile media includes, for example, optical or magnetic disks, such as storage device 308. Volatile media includes dynamic memory, such as volatile storage 306.

Common forms of computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, an EPROM, a FLASH-EPROM, a flash drive, a memory card, any other memory chip or cartridge, or any other medium from which a computer can read.

Various forms of computer readable media may be involved in carrying one or more sequences of one or more instructions to processor 305 for execution. For example, the instructions may initially be carried on a magnetic disk from a remote computer. Alternatively, a remote computer can load the instructions into its dynamic memory and send the instructions over a telephone line using a modem. A modem local to computer system can receive the data on the telephone line and use an infra-red transmitter to convert the data to an infra-red signal. An infra-red detector can receive the data carried in the infra-red signal and appropriate circuitry can place the data on the data bus 305. The bus 305 carries the data to the volatile storage 306, from which processor 305 retrieves and executes the instructions. The instructions received by the volatile memory 306 may optionally be stored on persistent storage device 308 either before or after execution by processor 305. The instructions may also be downloaded into the computer platform 301 via Internet using a variety of network data communication protocols well known in the art.

The computer platform 301 also includes a communication interface, such as network interface card 313 coupled to the data bus 305. Communication interface 313 provides a two-way data communication coupling to a network link 315 that is coupled to a local network 315. For example, communication interface 313 may be an integrated services digital network (ISDN) card or a modem to provide a data communication connection to a corresponding type of telephone line. As another example, communication interface 313 may be a local area network interface card (LAN NIC) to provide a data communication connection to a compatible LAN. Wireless links, such as well-known 802.11a, 802.11b, 802.11g and Bluetooth may also used for network implementation. In any such implementation, communication interface 313 sends and receives electrical, electromagnetic or optical signals that carry digital data streams representing various types of information.

Network link 313 typically provides data communication through one or more networks to other network resources. For example, network link 315 may provide a connection through local network 315 to a host computer 316, or a network storage/server 317. Additionally or alternatively, the network link 313 may connect through gateway/firewall 317 to the wide-area or global network 318, such as an Internet. Thus, the computer platform 301 can access network resources located anywhere on the Internet 318, such as a remote network storage/server 319. On the other hand, the computer platform 301 may also be accessed by clients located anywhere on the local area network 315 and/or the Internet 318. The network clients 320 and 321 may themselves be implemented based on the computer platform similar to the platform 301.

Local network 315 and the Internet 318 both use electrical, electromagnetic or optical signals that carry digital data streams. The signals through the various networks and the signals on network link 315 and through communication interface 313, which carry the digital data to and from computer platform 301, are exemplary forms of carrier waves transporting the information.

Computer platform 301 can send messages and receive data, including program code, through the variety of network(s) including Internet 318 and LAN 315, network link 215 and communication interface 213. In the Internet example, when the system 301 acts as a network server, it might transmit a requested code or data for an application program running on client(s) 320 and/or 321 through Internet 318, gateway/firewall 317, local area network 315 and communication interface 313. Similarly, it may receive code from other network resources.

The received code may be executed by processor 305 as it is received, and/or stored in persistent or volatile storage devices 308 and 306, respectively, or other non-volatile storage for later execution.

It should be noted that the present invention is not limited to any specific firewall system. The inventive policy-based content processing system may be used in any of the three firewall operating modes and specifically NAT, routed and transparent.

Finally, it should be understood that processes and techniques described herein are not inherently related to any particular apparatus and may be implemented by any suitable combination of components. Further, various types of general purpose devices may be used in accordance with the teachings described herein. It may also prove advantageous to construct specialized apparatus to perform the method steps described herein. The present invention has been described in relation to particular examples, which are intended in all respects to be illustrative rather than restrictive. Those skilled in the art will appreciate that many different combinations of hardware, software, and firmware will be suitable for practicing the present invention. For example, the described software may be implemented in a wide variety of programming or scripting languages, such as Assembler, C/C++, perl, shell, PHP, Java, etc.

Moreover, other implementations of the invention will be apparent to those skilled in the art from consideration of the specification and practice of the invention disclosed herein. Various aspects and/or components of the described embodiments may be used singly or in any combination in the methods and systems for controlling interactive video using voice commands. It is intended that the specification and examples be considered as exemplary only, with a true scope and spirit of the invention being indicated by the following claims.

What is claimed is:

1. A computerized system for controlling interactive video using voice commands, the system comprising:
a. a control module deployed on a mobile device and configured to detect a voice command issued by a user and to transmit the detected user's voice command to the server;
b. a voice-to-text conversion module deployed on the server and configured to perform conversion of the user's voice command to a text command;
c. a text comparison module configured to perform comparison of the words in the converted text command received from the voice-to-text conversion module with keywords stored in an interactive video file;
d. an interactive content overlay module configured to display an interactive content corresponding to the user's voice command by overlaying the interactive content over a video content displayed to the user;
e. a dynamic content display module configured to dynamically display the interactive content to the user; and
f. a content storage module configured to control storing of the interactive video file containing the interactive content.

2. The computerized system of claim 1, wherein the interactive video file comprises:
a. positional coordinates of an object in the video frame of the interactive video;
b. a time interval when the object appears in the video;
c. at least one keyword associated with the object;
d. a type of interactive action to be initiated upon the receipt of the command from the user; and
e. a content to be displayed to the user.

3. The computerized system of claim 1, wherein the keywords comprise content keywords associated with one or more objects in the interactive video file and command keywords associated with one or more actions which may be performed in connection with the interactive video.

4. The computerized system of claim 1, wherein the interactive content overlay module is configured to display the interactive content corresponding to the user's voice command in a translucent manner.

5. The computerized system of claim 1, wherein the interactive content overlay module is configured to display the interactive content corresponding to the user's voice command in a pop-up window.

6. The computerized system of claim 1, wherein the computerized system is configured to display a hint to the user regarding one or more actions which may be performed in connection with the interactive video.

7. The computerized system of claim 1, wherein the computerized system is configured to send email comprising the interactive content corresponding to the user's voice command to the user.

8. A computer-implemented method for controlling interactive video using voice commands, the method comprising:
a. using a control module deployed on a mobile device and configured to detect a voice command issued by a user and to transmit the detected user's voice command to the server;
b. using a voice-to-text conversion module deployed on the server and configured to perform conversion of the user's voice command to a text command;
c. using a text comparison module configured to perform comparison of the words in the converted text command received from the voice-to-text conversion module with keywords stored in an interactive video file;
d. using an interactive content overlay module configured to display an interactive content corresponding to the user's voice command by overlaying the interactive content over a video content displayed to the user;
e. using a dynamic content display module to dynamically display the interactive content to the user; and
f. using a content storage module to control storing of the interactive video file containing the interactive content.

9. The computer-implemented method of claim 8, wherein the interactive video file comprises:
a. positional coordinates of an object in the video frame of the interactive video;
b. a time interval when the object appears in the video;
c. at least one keyword associated with the object;
d. a type of interactive action to be initiated upon the receipt of the command from the user; and
e. a content to be displayed to the user.

10. The computer-implemented method of claim 8, wherein the keywords comprise content keywords associated with one or more objects in the interactive video file and command keywords associated with one or more actions which may be performed in connection with the interactive video.

11. The computer-implemented method of claim 8, wherein the interactive content corresponding to the user's voice command is displayed in a translucent manner.

12. The computer-implemented method of claim 8, wherein the interactive content corresponding to the user's voice command is displayed in a pop-up window.

13. The computer-implemented method of claim 8, further comprising displaying a hint to the user regarding one or more actions which may be performed in connection with the interactive video.

14. The computer-implemented method of claim 8, further comprising sending email comprising the interactive content corresponding to the user's voice command to the user.

15. A non-transitory computer-readable medium embodying a set of instructions, which, when executed by one or more processors cause the one or more processors to perform a computer-implemented method for controlling interactive video using voice commands, the method comprising:
a. using a control module deployed on a mobile device and configured to detect a voice command issued by a user and to transmit the detected user's voice command to the server;
b. using a voice-to-text conversion module deployed on the server and configured to perform conversion of the user's voice command to a text command;
c. using a text comparison module configured to perform comparison of the words in the converted text command received from the voice-to-text conversion module with keywords stored in an interactive video file;
d. using an interactive content overlay module configured to display an interactive content corresponding to the user's voice command by overlaying the interactive content over a video content displayed to the user;
e. using a dynamic content display module to dynamically display the interactive content to the user; and
f. using a content storage module to control storing of the interactive video file containing the interactive content.

16. The non-transitory computer-readable medium of claim 15, wherein the interactive video file comprises:
a. positional coordinates of an object in the video frame of the interactive video;
b. a time interval when the object appears in the video;
c. at least one keyword associated with the object;
d. a type of interactive action to be initiated upon the receipt of the command from the user; and
e. a content to be displayed to the user.

17. The non-transitory computer-readable medium of claim 15, wherein the keywords comprise content keywords associated with one or more objects in the interactive video file and command keywords associated with one or more actions, which may be performed in connection with the interactive video.

18. The non-transitory computer-readable medium of claim 15, wherein the interactive content corresponding to the user's voice command is displayed in a translucent manner.

19. The non-transitory computer-readable medium of claim 15, wherein the interactive content corresponding to the user's voice command is displayed in a pop-up window.

20. The non-transitory computer-readable medium of claim 15, wherein the method further comprises displaying a hint to the user regarding one or more actions, which may be performed in connection with the interactive video.
